(19) United States
(12) Patent Application Publication
(10) Pub. No.: US 2018/0317295 A1
(43) Pub. Date: Nov. 1, 2018

(54) DRESSING ROOM LIGHTING SYSTEM

(71) Applicant: AMERLUX LLC, Oakland, NJ (US)

(72) Inventors: Itai Leshniak, Fair Lawn, NJ (US); Harish Meisuria, New Windsor, NY (US)

(21) Appl. No.: 15/963,853

(22) Filed: Apr. 26, 2018

Related U.S. Application Data
(60) Provisional application No. 62/490,477, filed on Apr. 26, 2017.

(51) Int. Cl. H05B 33/08; H05B 37/02

(52) U.S. Cl. CPC H05B 33/0863; G06Q 30/0201; H05B 37/0272

(57) ABSTRACT

A user controllable lighting system for a dressing room and a method for retrofit of a dressing room with a lighting system are disclosed herein.

### CROSS REFERENCE TO RELATED APPLICATIONS

This application is filed under 35 U.S.C. § 111(a) and further, under 35 U.S.C. § 119(e), claims the benefit of U.S. Provisional Patent Application Ser. No. 62/490,477, filed Apr. 26, 2017 and entitled “Dressing Room Lighting System,” the entire disclosure of which is incorporated herein by reference for any purpose whatsoever.

### BACKGROUND OF THE INVENTION

### 1. Field of the Invention

The invention disclosed herein relates to lighting systems, and in particular to controllable lighting for use in dressing rooms.

### 2. Description of the Related Art

All clothing, accessories, jewelry (department) stores have a dressing room, in every dressing room there is a mirror to see how the clothing, accessories, jewelry looks once you put them on. It is known in the lighting industry and in the fashion industry that different color light, including different types of white light, can make a difference in the way your clothing, accessories such as jewelry look. For example, a sunny summer day will have a high blue and violet component in the white light. However, the lighting in a restaurant will typically have a lot red light, with no violet and very low blue components. As can be understood, there are many different locations, weather, and scenes that will affect the way things look.

Some clothing, accessories, jewelry can look very different under a different light, for example a set of eye glasses that have a purple frame will look great on a sunny day but in a restaurant using dimmed incandescent light the purple will appear as brown. A similar effect may be noticed for items containing fluorescence elements (that is, optical brightener). One example of an optical brightener is 4,4′-bis(benzoxazol-2-yl)stilbene. Typical fluorescence elements require violet or ultraviolet (UV) light and will not work well under low corrected color temperature (CCT) white light only under the effect of violet or UV enhanced light.

These effects are not unknown to consumers. Accordingly, some retail shoppers may hesitate making a purchase. That is, when trying on apparel or accessories, the lighting may not flatter the potential purchase. As a result, some purchases are never consummated.

Thus, what are needed are methods and apparatus to enhance the shopping experience of a retail consumer of apparel and accessories. Preferably, the methods and apparatus result in a highly configurable lighting system that provides realistic, situational lighting for the consumer.

### SUMMARY OF THE INVENTION

In one embodiment, a lighting system for a dressing room is provided. The lighting system includes at least one lighting circuit including at least one lighting element configured for being disposed in the dressing room; an interface configured for installation with the dressing room and controlling the at least one lighting circuit; and an app configured for download from to a user device, the app including machine executable stored on non-transitory machine readable media, the app including instructions to control operation of the at least one lighting circuit when installed in the dressing room.

The at least one lighting element may include at least two LED lighting elements. The app may offer a customer incentive, the customer incentive including at least one of a coupon, points, a prize and a loyalty reward. The app may serve customer data to a system operator; the customer data may be useful for analyzing shopping behavior of a customer in possession of the user device. The interface may be configured for limiting access to the lighting system. The app may be configured to control the lighting system according to at least one preset value; and the at least one preset value may control at least one of color, hue, power, and brightness. The app may be configured to enable communication between the user device and the interface by a protocol that includes at least one of Bluetooth, wifi, LiFi, NFC, infrared and networked communications.

In another embodiment, a customer controlled lighting system includes at least one lighting circuit including at least one lighting element for being disposed in a customer oriented display of a retailer; an interface configured for controlling the at least one lighting circuit and communicating with a user device of the customer and a server of the retailer; and an app configured for download from the interface to the user device, the app including machine executable instructions stored on non-transitory machine readable media, the app including instructions to control operation of the at least one lighting circuit when installed in the customer oriented display.

The customer oriented display may include one of a dressing room, a hotel room, a bathroom, a portion of a restaurant, a portion of a home store, a paint display, a kitchen display and a flooring display. The customer oriented display may include at least one of a cradle and a charging system for the user device. The interface may be configured with at least one of: communications software to enable communications with the user device; analytics software configured to at least one of collect data and analyze data from the user device; and control software to receive commands and enable control of the lighting elements.

In yet another embodiment, an app for controlling a customer oriented lighting system is provided. The app includes: a set of machine executable instructions stored on non-transitory machine readable media, the instructions configured for controlling a lighting system of a customer oriented display of a retailer to enhance promotion by implementation with a user device of a customer; the instructions configured for initiating communications between the user device and the lighting system upon a request of the customer; the instructions further configured for providing user controls for the customer to access and control at least one aspect of the lighting system; the instructions further including an interface to a server of the retailer for development of automated development of analytics data descriptive of a shopper profile for the customer as well as development of promotional incentives for customer offers; and, an incentives menu for receiving at least one customer offer as an incentive and offering the customer offer to the customer to promote sales of the retailer.

The app may further include a facility for providing the customer with access to an online presence of the retailer. The app may further include a facility for providing the customer with advertising of the retailer. The app may be configured to enable communication between the user device and the interface by a protocol that includes at least one of Bluetooth, wifi, NFC, infrared and networked communications.

### BRIEF DESCRIPTION OF THE DRAWINGS

The features and advantages of the invention are apparent from the following description taken in conjunction with the accompanying drawings in which:

FIG. 1 is an schematic diagram depicting an exemplary embodiment of a dressing room;

FIGS. 2A and 2B, collectively referred to herein as FIG. 2, each provide an exemplary user interface for control of lighting in the dressing room of FIG. 1;

FIG. 3 is a flow chart providing an exemplary process for installing a lighting system according to the teachings herein.

### DETAILED DESCRIPTION OF THE INVENTION

Disclosed herein are methods and apparatus for controlling lighting in a dressing room and a dressing room area. The teachings herein provide users with the ability to control color, intensity and other characteristics of the lighting. Once a user enters the dressing room area, the user may invoke a retailer supplied app to control the lighting. In addition to providing users with the ability to control the lighting, the retailer may rely on the app to gain marketing information.

Prior to discussing the teachings herein in greater detail, some context is provided.

As discussed herein, a “user” is an individual that benefits from or takes advantage of the facilities and services provided by a retailer for qualifying goods when considering a purchase. The term “user” may be interchanged with the term “customer” as deemed appropriate. As discussed herein, a “retailer” is an individual or enterprise that offers goods or services for sale to the general public. Generally, the retailer will conduct business within a retail establishment. The retailer may interface directly with users or customers, and/or may engage intermediaries, such as contract information technology service providers. As discussed herein, where intermediaries are involved in the business of the retailer, it is considered that such activity is that of the retailer.

As discussed herein, the term “dressing room” generally refers to a private area where a user may change apparel. A “dressing room area” includes portions of a facility in the vicinity of the dressing room where the user may continue with evaluation of the purchase. Examples include a hallway that may be at least partially adorned with mirrors and lighting. Although exemplary embodiments discussed herein are presented in terms of a dressing room, the technology disclosed is not limited to use in a retail apparel environment unless such limitation is specifically stated. Other environments where the technology may be useful include, without limitation: in hotel rooms for setting of ambient lighting or control of specific lighting, such as a bedside lamp; in bathrooms and powder rooms; as a part of a retail display such as for those of an interior decorator or store offering goods such as flooring, window treatments, cabinetry, appliances and other home goods; paint stores; and other goods where sales may be appearance driven.

As discussed herein, the term “user device” generally refers to a handheld mobile communications device that has computing and communications capabilities. The user device includes a user oriented display with pointing and selection capabilities. Most commonly, pointing and selection is accomplished through use of a touch screen. Although exemplary embodiments of the user device discussed herein are presented in terms of a smartphone, the technology disclosed is not limited to use with a smartphone, and other devices such as tablet computers may be used.

As discussed herein, an “app” generally refers to a purpose oriented application that may include network communications as part of the functionality. Each app is operable on a user device such as a smartphone or tablet computer. The user device may include conventional software such as productivity tools (e.g, e-mail, word processing, spreadsheets, etc), at least one browser and a plurality of other apps. Generally, each user device is equipped with a voice channel for voice communications and a data channel for communicating data with external devices, such as a communications system of a retailer.

As discussed herein, generally, the term “color” refers to either one of those colors that can be produced by visible light of a single wavelength only, the pure spectral or monochromatic colors. Most light sources emit light at many different wavelengths; a source's spectrum is a distribution giving its intensity at each wavelength. Although the spectrum of light arriving at the eye from a given direction determines the color sensation in that direction, there are many more possible spectral combinations than color sensations. In fact, one may formally define a color as a class of spectra that give rise to the same color sensation, although such classes would vary widely among different species, and to a lesser extent among individuals within the same species. The color of an object depends on both the physics of the object in its environment and the characteristics of the perceiving eye and brain. Physically, objects can be said to have the color of the light leaving their surfaces, which normally depends on the spectrum of the incident illumination and the reflectance properties of the surface, as well as potentially on the angles of illumination and viewing. Some objects not only reflect light, but also transmit light or emit light themselves, which also contribute to the color. A viewer's perception of the object's color depends not only on the spectrum of the light leaving its surface, but also on a host of contextual cues, so that color differences between objects can be discerned mostly independent of the lighting spectrum, viewing angle, etc. This effect is known as color constancy.

| | Wavelength | |
|---|---|---|
| Color | Interval | |
| Red | ~700-635 | nm |
| Orange | ~635-590 | nm |
| Yellow | ~590-560 | nm |
| Green | ~560-520 | nm |
| Cyan | ~520-490 | nm |
| Blue | ~490-450 | nm |
| Violet | ~450-400 | nm |
| Ultraviolet | <400 | nm |

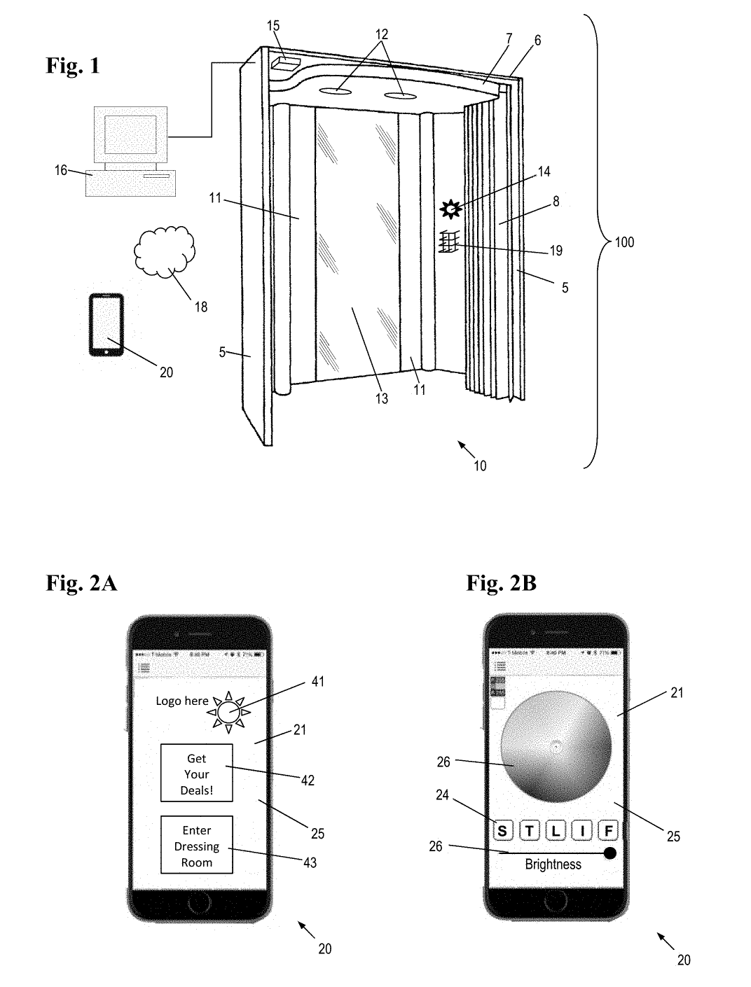

FIG. 1 is a schematic diagram depicting a lighting system 100 for a dressing room 10. FIG. 1 shows the dressing room 10 in a condition in which an entrance is in an opened position. In the dressing room 10, a mirror 13, such as a full-length mirror in which a customer views himself or herself while trying clothes on, is attached to a wall on the side opposite from the entrance. In this example of a dressing room 10, the entrance is opened and closed by drawing a curtain 8. The curtain 8 is suspended from above by a curtain suspension apparatus. When opening, the curtain 8 folds away at one side of the entrance, as shown in FIG. 1.

The dressing room 10 of this embodiment includes sidewalls 5 joined by a top member 6. A separate ceiling 7 may be provided under the top member 6. The space between the ceiling 7 and the top member 6 may contain power supplies for lighting, communications equipment, as well as suspension apparatus for curtain 8.

The dressing room 10 includes a plurality of lighting elements. In this example, a first circuit of lighting elements 11 is provided lateral to the mirror 13 and provides mirror lighting. A second circuit of lighting elements 12 is included in the ceiling 7, and provides ceiling lighting. Generally, the lighting elements include a plurality of light emitting diodes (LED). The lighting elements may be tunable, such that aspects such as color and intensity of produced light may be varied. In some embodiments, each of the lighting elements are individually addressable. In some embodiments, additional types of lighting elements are included within a particular lighting circuit. For example, the lighting system 100 may include LED lighting elements that may be at least one of LEDs producing a white color (CCT between about 3000 K to 6000 K) and LEDs producing a monochromatic color.

Although shown as disposed alongside the mirror 13 and attached to the ceiling 7, the lighting elements may be included anywhere within the dressing room 10 that is deemed suitable.

As shown, the lighting elements may be on separate circuits 11, 12. Other circuits may be included. In short, any number of lighting elements and circuits to control the lighting elements may be employed, at least some of which are controllable with the app. Control of each individual circuit or lighting element may include controlling power, color and intensity as well as any other parameters deemed appropriate.

An interface 15 is provided within or proximate to the dressing room 10. Generally, the interface 15 enables communications capability for controlling the lighting elements. Generally, the communications are controlled through a user device 20. In one embodiment, the user device 20 is a smart phone. The communications protocol employed by the interface 15 may include at least one of Bluetooth, Wi-Fi, LiFi, NFC, USB and any other technology deemed appropriate. Aspects of communications may be facilitated through a network 18.

In this example, the interface 15 includes a processor configured with communications software stored on non-transitory media included therewith. The communications software is provided to enable communications with the user device 20. The communications software may also enable communications with a server of the retailer 16. Among other things, the server may serve apps for download by the user device 20. The server 16 (and/or interface 15) may also contain a processor configured with analytics software stored on non-transitory media included therewith, the analytics software being configured to at least one of collect data and analyze data from the user device 20 through the interface 15. The interface 15 may also include control software stored on non-transitory media included therewith. The control software is provided to receive commands and enable control of the lighting elements.

When the lighting system 100 disclosed herein is in operation, a user will enter the dressing room 10 in order to try on some apparel. Once the user has donned the apparel, the user will assess the fit and appeal by gazing into the mirror 13. The lighting of the retail environment, such as the ambient fluorescent lighting in a retail environment, may not be well-suited to assessing the fit and appeal of the apparel. Accordingly, the user may wish to launch an app on their user device 20 (i.e., smart phone). The app may be used to control at least one of the color and intensity of the light produced by the lighting elements in at least one of the first circuit of lighting elements 11 and the second circuit of lighting elements 12.

In order to obtain the app, the dressing room 10 may include access information 14. An example of access information 14 is a QR code, bar code or other type of information. The access information 14 may be provided as a web address or signify an app to download from an app store. The access information 14 may be conveyed by use of NFC or a similar technology. Near-field communication (NFC) is a set of communication protocols that enable two electronic devices, one of which is usually a portable device such as a smartphone, to establish communication by bringing the device within a short distance of the other electronic device. Regardless of how the access information 14 is obtained, the user may use the access information 14 to obtain access to an app suited for controlling the lighting in the dressing room. Access to the app may be through conventional techniques, such as a repository hosted by a third party. Once installed, the user may initiate communications with a control system for the lighting elements in at least one of the first circuit of lighting elements 11 and the second circuit of lighting elements 12 through interface 15.

In some embodiments, such as where NFC technology is employed, the dressing room 10 includes a cradle 19. In this illustration, the cradle 19 is shown as a basket proximate to an NFC antenna (for example, where access information 14 is disposed). By including a cradle 19, the user may keep the user device 20 in communication with the dressing room 10 using an NFC circuit. In some embodiments, the cradle 19 includes charging capabilities, such as those provided by a USB charging cable (not shown). Advantageously, the cradle 19 permits users to maintain communications with the dressing room 10, hands free availability of the user device 20 and limits opportunities for tampering with the lighting system through a network or other widely accessible implementation. When the user removes the user device 20 from the cradle 19, communication with the dressing room 10 terminates and control is available for the next individual.

Advantageously, the system disclosed herein provides users with a high degree of control over the lighting in the dressing room 10. Additionally, the controls are at least partially implemented through software, thus reducing system expense and limiting wear and tear from use, vandalism and the like.

Once the app has been downloaded, the user may set up an account. In return, the retailer may offer benefits such as discounts, loyalty awards, bundled offers and the like. As most retailers make use of tracking devices, such as radiofrequency identification tags (RFID), Bluetooth and wifi, the retailer may be enabled to track evaluation and purchasing of products as well as consumer behavior. Other information (dressing room intelligence) regarding the retailing activities as may be collected by the retailer may be included, and may be aggregated and/or specifically associated with the user.

An example of a user device 20 is depicted in FIGS. 2A and 2B. In this example, the user device 20 is a smartphone. The smartphone includes a display 21, which is displaying an embodiment of an user interface for the app 25. In FIG. 2A, display 21 of the user device 20 displays an opening screen for the app 25. The opening screen or home screen includes the identity 41 of the retailer, an incentives menu 42 and a lighting control menu 43. In this illustration, each of the incentives menu 42 and the lighting control menu 43 are provided as button for the user to select a sub-menu. A display correlating to selection of the incentives menu 42 is not shown, however, an example of a lighting control screen is shown in FIG. 2B.

It should be noted that the screen shown in FIG. 2B does not include additional features for selection of a particular one of the lighting circuits, however, these may be included. In one example, pressing the button for the lighting control menu 43 leads the user to an intermediate screen (not shown) which includes an illustration of the lighting elements in the dressing room 10. Once the user touches the display 21 at the location of a particular lighting element for adjustment, the particular lighting element and others on the same circuit are illuminated briefly, and entrance to the lighting control menu of FIG. 2B is granted.

In FIG. 2B, the app 25 includes a series of predetermined system settings (referred to as “presets”) 24 for certain types of lighting. For example, presets 24 are presented for sunlight (S), twilight (T), low light (L), incandescent (I) and fluorescent (F) lighting. By selecting one of these presets, the app 25 will send a command through interface 15 to the control system for the lighting elements in at least one of the first circuit of lighting elements 11 and the second circuit of lighting elements 12. The control system will then adjust output of the lighting elements in at least one of the first circuit of lighting elements 11 and the second circuit of lighting elements 12 according to predetermined settings associated with a respective one of the presets 24.

Generally, each preset reflects a configuration for the lighting elements to produce a desired effect. More specifically, each preset contains predetermined values for aspects such as intensity, color and hue for each of the lighting elements. For some presets, some of the lighting elements may be turned off or down.

Optionally, custom controls 26 may be provided. In this example, the custom controls 26 provide users with capabilities to select a custom color and a custom brightness for at least one of the first circuit of lighting elements 11 and the second circuit of lighting elements 12.

In some embodiments, the lighting system 100 includes security features. For example, the interface 15 may be configured with Bluetooth communications, such that the user must remain within the dressing room 10 in order to maintain communications. Once the user is some distance from the dressing room 10, communication with the interface 15 is broken and another user may assume control of the lighting system 100. In some embodiments, the interface 15 is realized through an NFC communications channel.

In some other embodiments, communication with the user is maintained for a defined period of time. For example, once the user assumes control of the lighting system, a timer may commence countdown. Once the countdown has concluded, communication with the user device 20 is terminated. In some embodiments, a rolling security code is used.

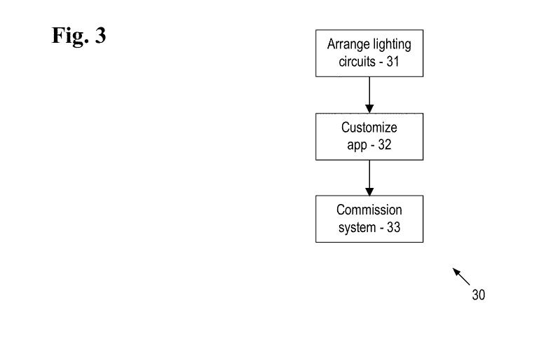

FIG. 3 depicts an exemplary method for installation of an embodiments of the lighting system 100 according to the teachings herein. In a first step 31, an installer installs at least one to a plurality of lighting elements and arranges the lighting elements in appropriate circuitry. In a second step 32, the installer, retailer, and/or service provider customizes the app. This may include building appropriate associations with the installed circuitry, setting network information, scheduling retail inducements, programming the access information 14 and performing other such tasks. In a third step 33, the installed system is made available for use by the users.

Having disclosed aspects of a controllable lighting system, some additional features and embodiments are now introduced.

The teachings herein are not limited to implementation in dressing rooms. For example, systems may be installed in hotel rooms, bathrooms, restaurants, home stores, including paint displays, kitchen displays, flooring displays and other such places. The lighting system of the dressing room installation and other embodiments as may be used by a retailer are generally referred to herein as “customer controlled lighting systems” and by other similar terms.

The app disclosed herein may be integrated into another app. For example, a retailer may include the functionality disclosed herein into an existing shopping app for that retailer.

Some advantages of the teachings herein include enabling users to view potential purchases in realistic lighting, thus reducing the guesswork involved in the assessment of the look and feel or appearance of particular garments. Additionally, the users may be provided with various customer incentives such as coupons, points, prizes and other loyalty rewards. System operators, such as retailers and their contractors or service providers, may take advantage of the app installed on a user device for obtaining customer data. The customer data may include monitoring tracking whereabouts of the user within the store or beyond, and may include derived data, such as shopping interests, demographics, etc. The system operators may enable the app with any type of analytics capabilities as deemed appropriate in order to at least one of collect and produce the customer data.

Generally, each user device is configured to store machine executable instructions on non-transitory machine readable media (such as in read-only memory (ROM), random-access-memory (RAM), flash memory, or in a non-volatile storage unit such as a hard disk, solid state drive, or the equivalent). The machine executable instructions may be referred to herein as “software,” as an “application,” an “app,” a “client,” a “process,” a “plug-in,” an “add-in,” an “add-on,” an “extension,” and by other similar terms. The machine executable instructions generally provide for functionality through operation of various methods as may be presented herein as well as others that may be apparent to those skilled in the art.

Some of the machine executable instructions stored on non-transitory machine readable media may include an operating environment also referred to as an operating system. For example, and as presented herein, a suitable operating environment is WINDOWS (available from Microsoft Corporation of Redmond Wash.). Other operating environments include iOS from Apple of Cupertino Calif. and ANDROID available from Alphabet of Mountain View Calif. Software as provided herein may be developed in, for example, SQL language, which is a cross-vendor query language for managing relational databases. Aspects of the software may be implemented with other software. For example, user interfaces may be provided in XML, HTML, a variety of scripting languages and the like.

More specifically, given the highly configurable nature of computing systems, the terms “computer” and “user device” as well as other similar terms are to be construed to include any configuration of components and/or software as needed to provide for the intended functions as well as extensions thereof.

Various other components may be included and called upon for providing for aspects of the teachings herein. For example, additional materials, combinations of materials and/or omission of materials may be used to provide for added embodiments that are within the scope of the teachings herein.

A variety of modifications of the teachings herein may be realized. Generally, modifications may be designed according to the needs of a user, designer, manufacturer or other similarly interested party. The modifications may be intended to meet a particular standard of performance considered important by that party.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. As used herein, the term “exemplary” is not intended to imply a superlative example. Rather, “exemplary” refers to an embodiment that is one of many possible embodiments.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A lighting system for a dressing room, comprising:
at least one lighting circuit comprising at least one lighting element configured for being disposed in the dressing room;
an interface configured for installation with the dressing room and controlling the at least one lighting circuit; and
an app configured for download to a user device, the app comprising machine executable stored on non-transitory machine readable media, the app comprising instructions to control operation of the at least one lighting circuit when installed in the dressing room.

2. The lighting system as in claim 1, wherein the at least one lighting element comprises at least one of an LED producing a white color and an LED producing a monochromatic color.

3. The lighting system as in claim 1, wherein the app offers a customer incentive, the customer incentive comprising at least one of a coupon, points, a prize and a loyalty reward.

4. The lighting system as in claim 1, wherein the app serves customer data to a system operator.

5. The lighting system as in claim 4, wherein the customer data is useful for analyzing shopping behavior of a customer in possession of the user device.

6. The lighting system as in claim 1, wherein the interface is configured for limiting access to the lighting system.

7. The lighting system as in claim 1, wherein the app is configured to control the lighting system according to at least one preset value.

8. The lighting system as in claim 7, wherein the at least one preset value controls at least one of color, hue, power, intensity, and brightness.

9. The lighting system as in claim 1, wherein the app is configured to enable communication between the user device and the interface by a protocol that includes at least one of Bluetooth, wifi, NFC, infrared and networked communications.

10. A customer controlled lighting system comprising:
at least one lighting circuit comprising at least one lighting element for being disposed in a customer oriented display of a retailer;
an interface configured for controlling the at least one lighting circuit and communicating with a user device of the customer and a server of the retailer; and
an app configured for download from the interface to the user device, the app comprising machine executable instructions stored on non-transitory machine readable media, the app comprising instructions to control operation of the at least one lighting circuit when installed in the customer oriented display.

11. The customer controlled lighting system as in claim 10, wherein the customer oriented display comprises one of a dressing room, a hotel room, a bathroom, a portion of a restaurant, a portion of a home store, a paint display, a kitchen display and a flooring display.

12. The customer controlled lighting system as in claim 10, wherein the customer oriented display comprises at least one of a cradle and a charging system for the user device.

13. The customer controlled lighting system as in claim 10, wherein the interface is configured with at least one of: communications software to enable communications with the user device; analytics software configured to at least one of collect data and analyze data from the user device; and control software to receive commands and enable control of the lighting elements.

14. An app for controlling a customer oriented lighting system, the app comprising:
a set of machine executable instructions stored on non-transitory machine readable media, the instructions configured for controlling a lighting system of a customer oriented display of a retailer to enhance promotion by implementation with a user device of a customer;
the instructions configured for initiating communications between the user device and the lighting system upon a request of the customer;
the instructions further configured for providing user controls for the customer to access and control at least one aspect of the lighting system;
the instructions further comprising an interface to a server of the retailer for development of automated development of analytics data descriptive of a shopper profile for the customer as well as development of promotional incentives for customer offers; and,
an incentives menu for receiving at least one customer offer as an incentive and offering the customer offer to the customer to promote sales of the retailer.

15. The app as in claim 14, further comprising a facility for providing the customer with access to an online presence of the retailer.

16. The app as in claim 14, further comprising a facility for providing the customer with advertising of the retailer.

17. The app as in claim 14, wherein the app is configured to enable communication between the user device and the interface by a protocol that includes at least one of Bluetooth, wifi, NFC, infrared and networked communications.
